(19) United States
(12) Patent Application Publication
(10) Pub. No.: US 2010/0283300 A1
(43) Pub. Date: Nov. 11, 2010

(54) Vehicle seat apparatus

(76) Inventors: Dennis J. Gryp, East Moline, IL (US); Mark Copeland, Silvis, IL (US)

Correspondence Address: LANE & WATERMAN LLP, 220 N. MAIN STREET, SUITE 600, Davenport, IA, 52801, US

(21) Appl. No.: 12/387,715

(22) Filed: May 6, 2009

(51) Int. Cl. B60N 2/02; B60N 2/24

(52) U.S. Cl. 297/340

(57) ABSTRACT

The present invention is directed to a vehicle seat assembly comprising a seat assembly frame, a seat and backrest subassembly having a seat pivotally mounted to the frame and a backrest pivotally connected at its lower end to the seat, and a link pivotally connected to the backrest and the frame. The seat and backrest subassembly is movable between a first position to facilitate operation of the vehicle while the driver is sitting and a second position to facilitate operation of the vehicle with the driver standing. When the seat and backrest subassembly is moved from the first position to the second position, the seat moves from a generally horizontal orientation to a generally vertical orientation and the backrest moves upward and forward.

### BACKGROUND OF THE INVENTION

The present invention relates generally to vehicle seating and, more particularly, to a vehicle seat designed to facilitate operation of the vehicle with the operator in either a sitting or standing position. Such a seat finds advantageous use in refuse trucks and other work vehicles where the operator is boarding and exiting the vehicle frequently.

### SUMMARY OF THE INVENTION

The present invention is directed to a vehicle seat assembly comprising a seat assembly frame, a seat and backrest subassembly having a seat pivotally mounted to the frame and a backrest pivotally connected at its lower end to the seat, and a link pivotally connected to the backrest and the frame. The seat and backrest subassembly is movable between a first position to facilitate operation of the vehicle while the driver is sitting and a second position to facilitate operation of the vehicle with the driver standing. When the seat and backrest subassembly is moved from the first position to the second position, the seat moves from a generally horizontal orientation to a generally vertical orientation and the backrest moves upward and forward.

One object of the invention is to afford a simple and inexpensive dual purpose seat assembly that may be used effectively in either the sitting or standing position.

Another object of the invention is to provide a seat assembly that may be held in either of the sitting or standing position by an easily operated latching mechanism.

Yet another object of the invention is to provide a seat assembly that may be moved from the sitting to the standing position using only one hand, thereby facilitating use of the assembly.

Still a further object of the present invention is to provide a seat assembly that affords greater leg and foot room when in the standing position as compared to when the assembly is in the sitting position.

Another object of the invention is to provide a seat assembly that gives back support to the driver of the vehicle when the assembly is in the standing position, by moving the backrest upward and forward when in the standing position.

### BRIEF DESCRIPTION OF THE DRAWINGS

The novel features which are characteristic of the invention are set forth in the appended claims. However, the invention's preferred embodiments, together with further objects of the invention and its attendant advantages will be best understood by reference to the following detailed description and the accompanying drawings, in which:

FIG. 1 is a perspective view illustrating a seat constructed in accordance with the present invention and as used in a vehicle with the driver in a seated position;

FIG. 2 is a view similar to that of FIG. 1 but with the seat oriented so that the driver may operate the vehicle in a standing position;

FIG. 3 is an exploded perspective view showing details of the construction of various components of a seat made in accordance with one preferred embodiment of the invention;

FIG. 4 is a side view of one preferred embodiment of the present invention with the seat oriented for a driver operating the vehicle in a sitting position;

FIGS. 5, 6, 7 and 8 are all partial side views illustrating details of construction of the preferred embodiment illustrated in FIG. 4 and the special relationship of these components;

FIG. 9 is a side view similar to that of FIG. 4, but showing the seat as it moves from the sitting position toward the standing position; and

FIG. 10 is a side view similar to that of FIG. 4, but showing the seat oriented for a driver operating the vehicle in a standing position.

### DETAILED DESCRIPTION OF THE PREFERRED EMBODIMENTS

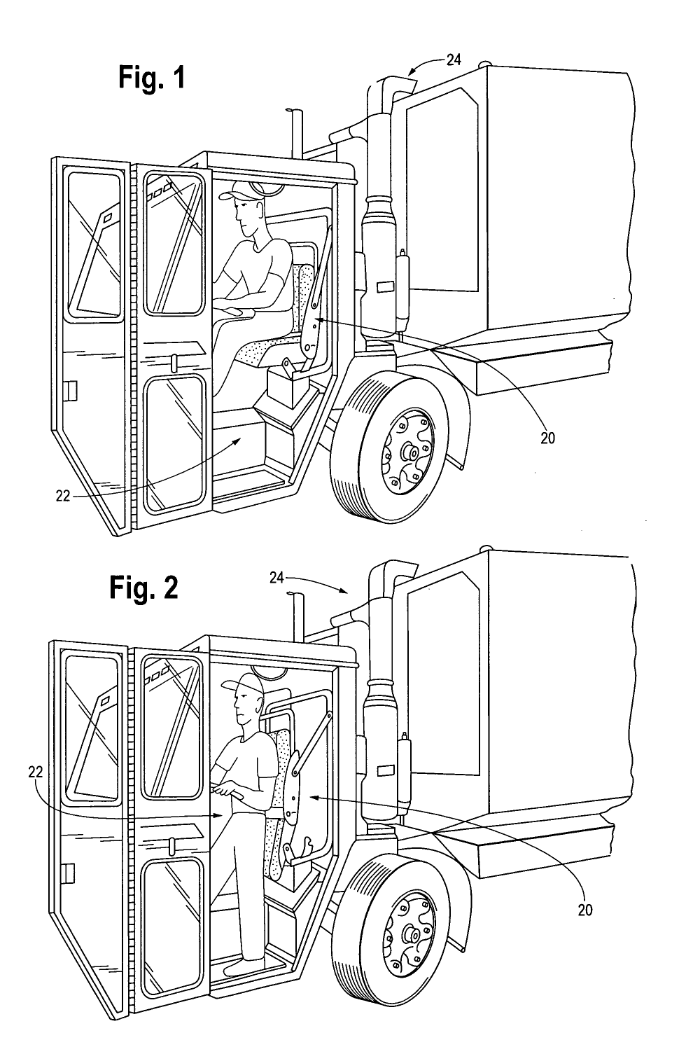

With reference to FIGS. 1 and 2, a seat assembly 20 is shown in accordance with one preferred embodiment of the present invention as it might be typically installed in the cab 22 of vehicle 24. In FIG. 1, the seat assembly is shown in a first position which accommodates a seated vehicle operator. This first position may be referred to herein as the “sitting position” for the seat assembly. In FIG. 2, the seat assembly is shown in a second position which accommodates a standing vehicle operator. This second position may be referred to herein as the “standing position” for the seat assembly.

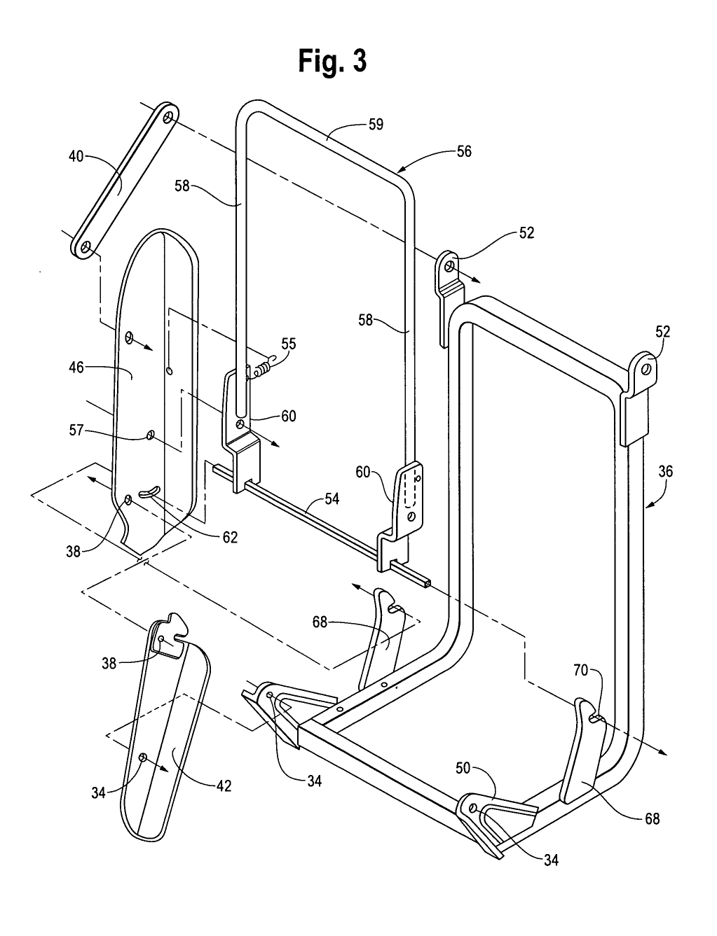

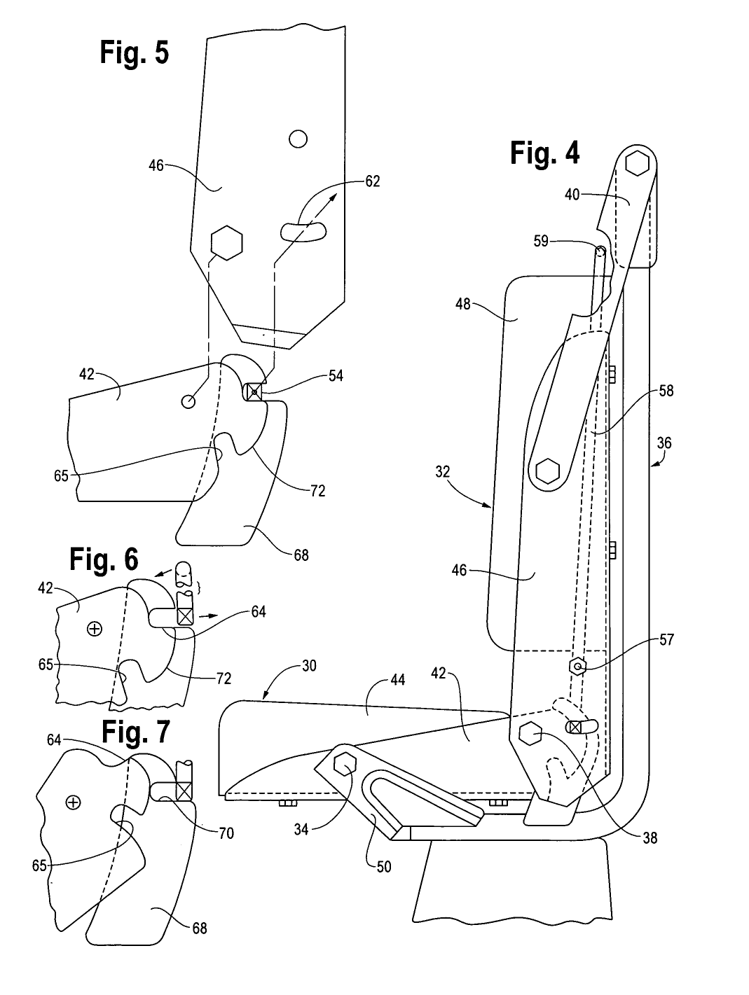

As shown in FIGS. 3 and 4, the seat assembly 20 is comprised of a seat and backrest subassembly having a seat 30 and a backrest 32. The seat is pivotally mounted at pivot point 34 to a seat assembly frame 36. The lower end of the backrest 32 is pivotally connected to the seat at pivot point 38 and is connected to the frame 36 via link 40. Although the invention as described in these preferred embodiments is shown with a seat assembly frame 36, the invention also contemplates that the functions performed by the frame 36 may be easily adapted to the wall or floor panels, or other structural components, of the vehicle cab 22.

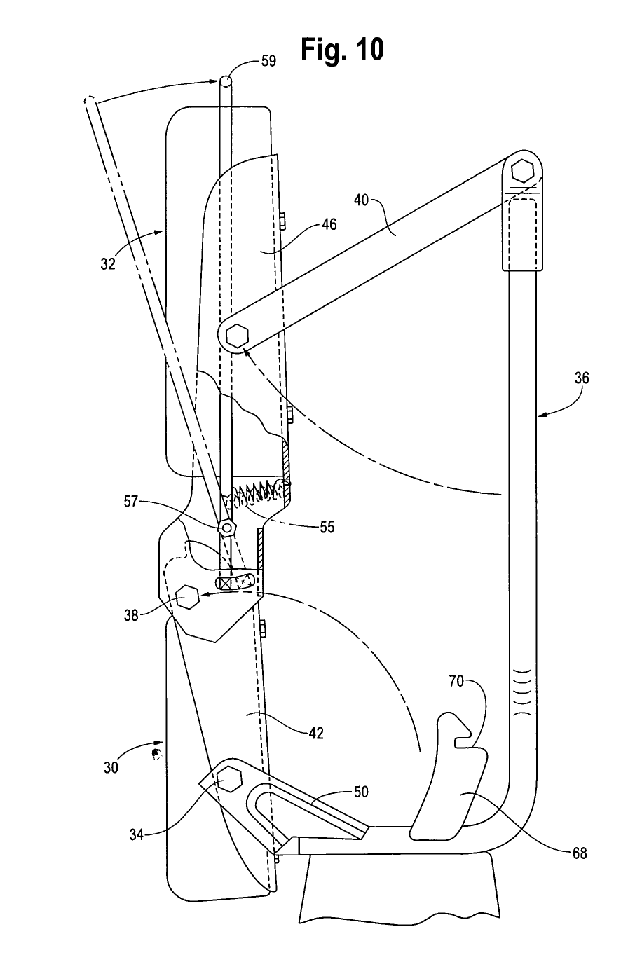

The seat 30 is constructed with opposing side brackets 42 which support a seat cushion 44. Likewise, the backrest 32 is constructed with opposing side brackets 46 which support a backrest cushion 48. The seat side brackets are pivotally joined to forward extension 50 of the frame 36. The backrest side brackets are joined by links 40 to the upper frame flanges 52. As a result of this arrangement, and as more clearly in FIGS. 9 and 10, as the seat assembly moves from the first “sitting position” toward the second “standing position,” the seat 30 rotates about pivot point 34 in a counterclockwise direction, while the backrest 32 moves upward and forward (with respect to the orientation of the vehicle). When in the second position, the seat 30 and backrest 32 are oriented in a generally vertical plane, as clearly shown in FIG. 10.

In accordance with the preferred embodiment, the seat assembly 20 also includes a latch bar 54 which is movable between engaged and disengaged positions, as more fully explained below. In the most preferred and illustrated embodiment, the latch bar 54 is actuated by a U-shaped latch handle 56 which is pivotally connected at pivot point 57 to the backrest side brackets 46. A spring 55 or other biasing device is employed to bias the latch 54 toward the engaged position. The backrest cushion 48 has a width less than the dimension between the opposing backrest side brackets 46, thereby defining a lateral space to accommodate the side rails 58 of the latch handle. Most preferably, the bight 59 of latch handle 56 is positioned above the top of the backrest 32, making it easily accessible to the vehicle operator. The latch bar 54 extends across the lower extremities of the latch handle side rails 58, and as shown clearly in FIG. 3, is most preferably joined to the side rails by extension brackets 60. The opposing ends of the latch bar extend laterally beyond each of the seat and backrest side brackets. In the case of the backrest side brackets, the ends of the latch bar pass through arcuate slots 62.

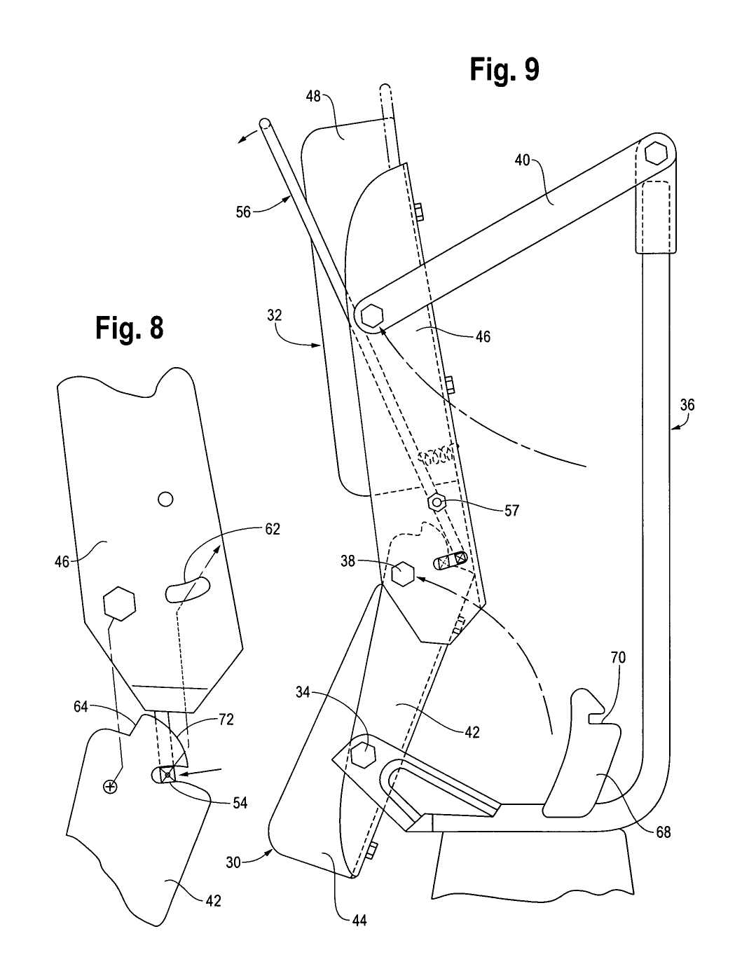

The following components cooperate with the latch bar 54 to maintain the seat assembly in either of the first or second positions. First, each of the seat side brackets has a rearward end shaped to define first and second retainers, 64 and 65 respectively. Secondly, the frame 36 includes an anchor flange 68 on each side, each of these flanges having a retaining slot 70. As shown in FIGS. 4, 5 and 6, when the seat assembly 20 is in the first “sitting position” the latch bar engages the top of retainer 64 and is nested within slot 70. When so arranged, the seat assembly cannot be moved from the first position. However, by moving the top 59 of the latch handle 56 forward and thereby pivoting latch handle 56 in a counterclockwise direction, the latch bar 54 is moved rearward away from retainer 64 and out of slot 70. A continued upward force on the latch handle will raise the seat and backrest subassembly, as shown in FIG. 9. Upon reaching the second position, and as shown in FIGS. 8 and 10, a release of the latch handle 56 will allow the spring 55 to rotate the latch handle in a clockwise direction and the latch 54 will move forward into retainer 65. This arrangement will maintain the seat assembly 20 in the second position, until the latch handle is pulled forward thereby releasing the latch from retainer 65 and allowing the seat assembly to drop back to the first “sitting” position. The rearward ends of the seat side brackets are also shaped to define an arcuate cam surface 72. This surface allows the latch bar 54 to slide smoothly between the retainers 64 and 65 as the seat assembly 20 moves from one position to the other.

It will be appreciated by those skilled in the art that various changes and modifications may be made to the illustrated embodiments without departing from the spirit of the present invention. As noted previously, the functions associated with the frame 36 may be achieved by designing the cab interior to meet those functions. Also, while the latch 54 is shown mounted to the backrest and engaging the seat, it is also within the scope of the present invention to mount the latch to different components and to engage other structures. All such modifications and changes are intended to be covered by the appended claims.

We claim:

1. A vehicle seat assembly comprising:
a seat assembly frame,
a seat and backrest subassembly comprising a seat pivotally mounted to the frame and a backrest pivotally connected at its lower end to the seat,
a link pivotally connected to the backrest and the frame, and
wherein the seat and backrest subassembly moves between a first position to facilitate sitting operation of the vehicle and a second position to facilitate standing operation of the vehicle, and when the seat and backrest subassembly moves from the first position to the second position the seat moves from a generally horizontal orientation to a generally vertical orientation and the backrest moves upward and forward.

2. The vehicle seat assembly of claim 1 further comprising a latch cooperating with the seat and backrest subassembly to maintain the subassembly in either of the first or second positions.

3. The vehicle seat assembly of claim 2 wherein the frame includes a retaining flange which also cooperates with the latch to maintain the seat and backrest subassembly in the first position.

4. The vehicle seat assembly of claim 2 further comprising a latch handle pivotally mounted to the seat and backrest subassembly and extending above the top of the back rest and a spring member adapted to urge the latch toward an engaged position.

5. The vehicle seat assembly of claim 4 wherein the latch handle is pivotally mounted to the backrest and a force applied to move the latch handle forward and upward will result in movement of the seat and backrest subassembly from the first position toward the second position.

6. The vehicle seat assembly of claim 2 wherein the seat includes opposing seat side brackets each having a rearward end shaped to define first and second retainers, the first retainer cooperating with the latch when the seat and backrest subassembly is in the first position and the second retainer cooperating with the latch when the seat and backrest subassembly is in the second position.

7. The vehicle seat assembly of claim 6 wherein the each of the rearward ends of the seat side brackets is also shaped to define an arcuate cam surface to engage the latch as the seat and backrest subassembly moves between the first and second positions.

8. A vehicle seat assembly comprising:
a seat and backrest subassembly comprising a seat pivotally mounted to a base and a backrest pivotally connected at its lower end to the seat,
a link pivotally connected to the backrest and a base, and
wherein the seat and backrest subassembly moves between a first position with the seat and backrest oriented at an angle to one another to facilitate sitting operation of the vehicle and a second position with the seat and backrest oriented generally vertical and coplanar to facilitate standing operation of the vehicle, and when the seat and backrest subassembly moves from the first position to the second position the seat moves from a generally horizontal orientation to a generally vertical orientation and the backrest moves upward and forward.
